(19) United States
(12) Patent Application Publication
(10) Pub. No.: US 2006/0188674 A1
(43) Pub. Date: Aug. 24, 2006

(54) Cement-based hydraulic flexible composites and package therefor

(76) Inventors: Mark Fernette, Lisle, IL (US); James Reicherts, Cary, IL (US); Ashish Dubey, Grayslake, IL (US)

Correspondence Address: GREER, BURNS & CRAIN, LTD., 300 SOUTH WACKER DRIVE, SUITE 2500, CHICAGO, IL, 60603, US

(21) Appl. No.: 11/334,166

(22) Filed: Jan. 18, 2006

Related U.S. Application Data
(63) Continuation-in-part of application No. 11/224,398, filed on Sep. 12, 2005.
(63) Continuation-in-part of application No. 11/224,403, filed on Sep. 12, 2005.
(60) Provisional application No. 60/646,968, filed on Jan. 24, 2005.

(51) Int. Cl. B28B 11/00

(52) U.S. Cl. 428/34.4

(57) ABSTRACT

A packaged membrane is adapted to be sold, stored and transported to the site of use. The membrane includes a base mat and a flexible cement-based coating applied to the base mat. The coating includes a hydraulic component and water. The membrane is then rolled and packaged in a tubular package. Preferably, the coating also includes a water-soluble, film forming polymer. It is also preferred that the hydraulic component include at least 50% fly ash by weight.

### CROSS REFERENCE TO RELATED APPLICATIONS

This application claims the benefit of U.S. Provisional Application No.60/646,968, filed Jan. 24, 2005, herein incorporated by reference, is a continuation-in-part of U.S. Ser. No. 11/224,398, entitled “Flexible and Rollable Cementitous Membrane and Method of Manufacturing It”, filed Sep. 12, 2005 and is a continuation-in-part of U.S. Ser. No. 11/224,403, entitled “Flexible Hydraulic Compositions”, filed Sep. 12, 2005, each of which are herein incorporated by reference.

### FIELD OF THE INVENTION

This invention relates to packaging for flexible hydraulic cement-based composites. Thin, flexible mats, made from cement-based hydraulic compositions are packaged in an economical and durable package.

### BACKGROUND OF THE INVENTION

Ceramic tiles are both beautiful and practical as surface coverings on floors and walls. They may be waterproof, easily cleaned, durable and can be decorated with an infinite variety of colors and designs. They are quite popular for use in bathrooms, kitchens and foyers where water is frequently present.

House construction commonly calls for wood to be used as subfloors and drywall to be installed on walls. If wood or drywall is repeatedly exposed to water, it swells as it soaks up water, then contracts as the water evaporates. These repeated cycles of expansion and contraction breaks down the cell walls, causing the substrate to soften, decay and disintegrate over time. When wet, these substrates may also be susceptible to attack by molds, causing additional damage.

If ceramic tiles are applied directly to wood or drywall, cycles of swelling and drying, and the resultant damage, cause problems with cracking and breaking of the ceramic tiles. Ceramic tiles are very rigid and brittle, and do not give or stretch when the underlayment moves laterally. When the underlayment moves laterally, the attached tile moves with it causing the tile to crack or break when adjacent areas of substrate move at different rates or in different directions. Additionally, if a cracked or broken tile is not replaced immediately, water will be able to seep through the crack, causing repeated cycles of swelling and contracting of the substrate, resulting further damage to the ceramic tiles.

Typically, 5/16″ (8 mm) or ½″ (12.7 mm) cement board, such as DUROCK® brand cement board manufactured by USG Corporation, Chicago, Ill., is used under ceramic tile to provide a compatible surface for bonding to the adhesive tile and to provide an underlayment that does not move laterally. If exposed to water, cement does not swell or degrade, adding strength and stability under the tiles.

However, the use of cement board has certain disadvantages. A 5/16″ (8 mm) thickness of cement board weighs about 3 pounds per square foot, and can cause fatigue in those who move it to or around the job site or while placing it in position to receive the ceramic tile. Fastening of the cement board to the subfloor requires a large number of fasteners that add extra labor to the cost of the job. Frequently, the board is cut to fit the underlayment at the edges or to go around corners or cabinets. During and after cutting, alkaline fibers in the dust and exposed edges can be irritating to skin or lungs. Thus, attempts have been made in the prior art to find an underlayment that is a good adhesive surface, does not move, yet is lighter in weight and less irritating than cement board.

Plastic sheeting has been used as an underlayment for ceramic tiles. It is thin, lightweight and provides a waterproof barrier. However, plastic has a poor surface for bonding of the mortar used to adhere the tiles.

Thin layers of a lightweight, waterproof concrete composition were used to make concrete canoes by engineering students at several universities for a contest in 2003. The University of Alabama at Huntsville team used a mixture of Portland cement, a latex, an acrylic fortifier, plastic microspheres and water. This mixture produced a composition that had good workability and water resistance. It had a weight of only 14.7 pounds per cubic foot (199 Kg/m³).

U.S. Pat. No. 6,455,615 to Yu discloses a flexible polymer modified cement that can be used alone or on a substrate. It is disclosed for use in concealed areas of construction engineering, water conservancy projects and municipal works. A hydraulic cement, a polymer dispersion and water are calendared to form sheets, then dried until the composition is firm. The hydraulic material optionally includes from 20% to about 50% other hydraulic materials, including fly ash, silica fume, metakaolin and slag.

Plastic shrink wrap or a rectangular cardboard box are used in the art for packaging of underlayments, however, these provide little protection to the underlayment materials. When shrink wrap packaging is used, it is easily punctured or torn, affording little or no protection. It is destroyed upon opening, and no longer available to store and protect any amount of the underlayment or tile membrane that is left when the job is complete. The underlayment can then become dusty or dirty, a condition which then hinders the ability of an adhesive to grip the surface of the underlayment when it is subsequently applied to the surface of the underlayment. Underlayment that is permanently removed from its packaging is also prone to damage since there is no protective covering. The roll of underlayment can be flattened or creased, the membrane punctured or the edges damaged if the underlayment roll is not protected from the environment. When the roll is flattened or creased, it will not roll out as smoothly during installation as a roll that has been protected.

Rectangular cardboard boxes are also known for packaging rolls of underlayment. However, these boxes offer little structural strength. Boxes that are stacked high in a warehouse or on a pallate for storage can become flattened, at least partially flattening the roll of underlayment from unrolling easily during use. Rectangular boxes cannot be stacked as tightly and take up more warehouse space than shrink-wrapped rolls, increasing the cost of shipping and storing the underlayment.

It can also be difficult to remove rolls of underlayment from a cardboard box. Closure for the box is generally located at one end of the box. When the underlayment is ready for packaging, it is rolled up into a cylinder and placed into the box. When the underlayment is released inside the box, it partially unrolls, expanding to fit the available space. Upon arrival at the job site, the underlayment is to be removed from the package, but it is difficult to grasp and remove from the box due to the expansion of the roll and the friction between the underlayment and the inside of the box. Grasping the free edge of the underlayment that is toward the interior of the box can cause the entire roll to uncoil, frustrating the user. Rolls of underlayment are also very heavy, weighing 25 pounds (11.4 Kg) or more. They are difficult to remove from a box, especially when the user cannot get a good grip on the roll to slide it from the package.

Unless it is particularly thick, rollable underlayments are generally packaged with the aid of a central roll on which the membrane is wound. Use of a central roll adds to the overall diameter of the finished roll, requiring larger packaging, storage and shipping space. This additional component adds to the cost of the packaged product and requires at least one additional processing step to place the central roll in position to receive the membrane.

Thus there is a need in the art for packaging of membranes that is cost effective and provides adequate protection for the membrane from being creased, punctured or scratched. This packaging should also provide storage for the membrane both before and after the package has initially been opened. Costs of materials and processing could also be reduced if the membrane could be rolled and packaged without the use of a central roll.

### SUMMARY OF THE INVENTION

These and other problems are solved by the present membrane and package of the present invention. A tile membrane is useful as an underlayment for ceramic tile and includes a base mat and a flexible coating applied to the base mat, the coating including a hydraulic component; and water. Preferably, the hydraulic component includes at least 50% fly ash by weight. It is also preferred that the coating include a water-soluble, film-forming polymer.

The resulting membrane is packaged in a cylindrical tube. Preferably, the package is a telescoping tube having a first portion and a second portion, whereby neither the first portion nor the second portion exceeds the length of the membrane when it is rolled for insertion into the tube. It is also preferred that no central roll be used when rolling the membrane.

The preferred membrane for use as an underlayment for ceramic tile includes a base mat having at least three plies, a center ply of a meltblown polymer sandwiched between two plies of spunbond polymer; and a flexible coating applied to the base mat, the coating having a hydraulic component, a polymer comprising a water-soluble, film-forming polymer; and water.

This membrane is waterproof for use between a substrate and ceramic tiles and is extremely flexible and resilient. It has very good tolerance to damage even after severe, repeated deformation cycles. The membrane has good moisture resistance and durability. The slurry of the hydraulic component sets very rapidly, especially when dried in an oven or kiln. There is virtually no plastic shrinkage induced cracking as the product dries. Water demand for processing the flexible coating is very low, and the mixture is flowable and self-leveling even at low water addition rates.

In addition to preparation of floor membranes, this composition is useful in a number of other applications. It can be used as a coating, a patching or repair material or as a mortar or grout. This composition is also useful for making architectural moldings, statutes and manufactured articles having either simple or complex shapes. It can be used as an alternative to plastics in many applications.

A tubular package provides both protection and storage for the membrane of this invention. The cylindrical shape is less likely to sag or crush than a rectangular box, particularly when the tube is constructed of an inner cylinder within an outer cylinder. Compared to shrink-wrapping, the tubular package is reusable and provides convenient storage space for unused portions of the membrane.

The opening in the tube is preferably positioned such that a portion of the underlayment protrudes from the package, giving a user a place to grasp the roll of membrane for its removal from the package.

Together with the preferred packaging material, the membrane is economical, takes up a minimal amount of space for storage and shipping, and does not require the use of a central roll for rolling the membrane.

### DETAILED DESCRIPTION OF THE DRAWINGS

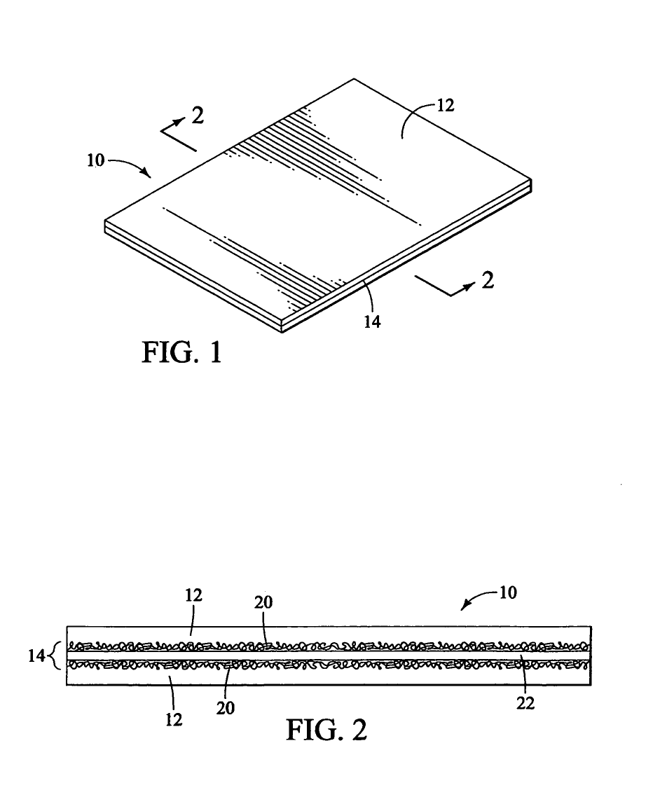

FIG. 1 shows a perspective view of the membrane of the present invention;

FIG. 2 shows a cross-sectional view of the tile membrane taken along line 2-2 of FIG. 1 and viewed from the direction indicated;

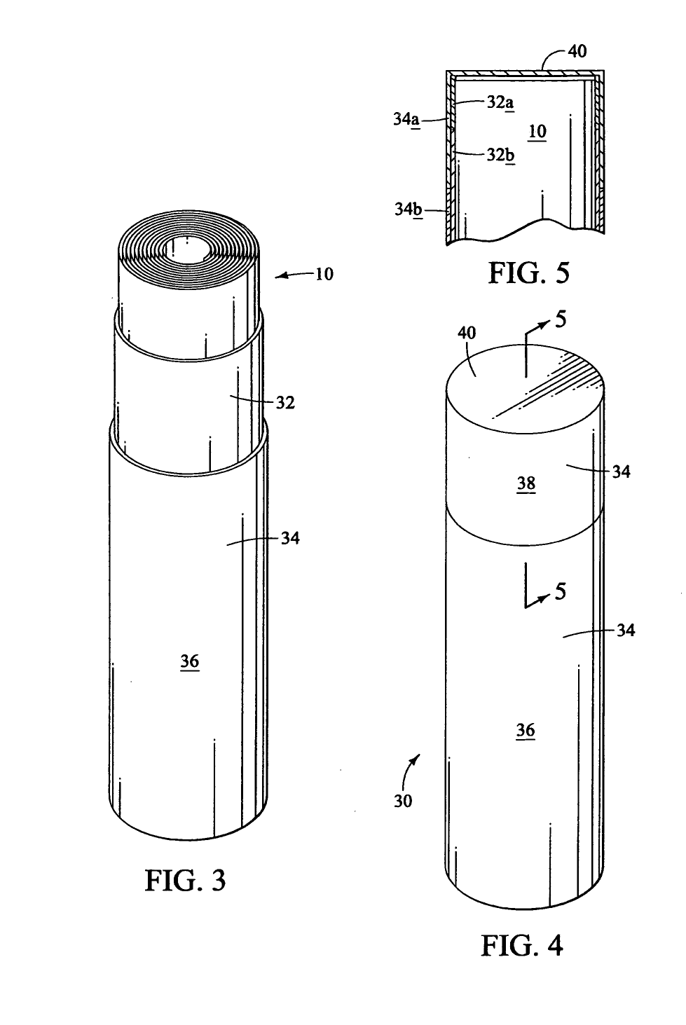

FIG. 3 is a front view of the rolled membrane inside the tubular package with the cover removed;

FIG. 4 is a front view of the closed package;

FIG. 5 is a cross-section of the second section of the package and a portion of the first section of the package taken along line 5-5 of FIG. 4 when viewed in the direction indicated;

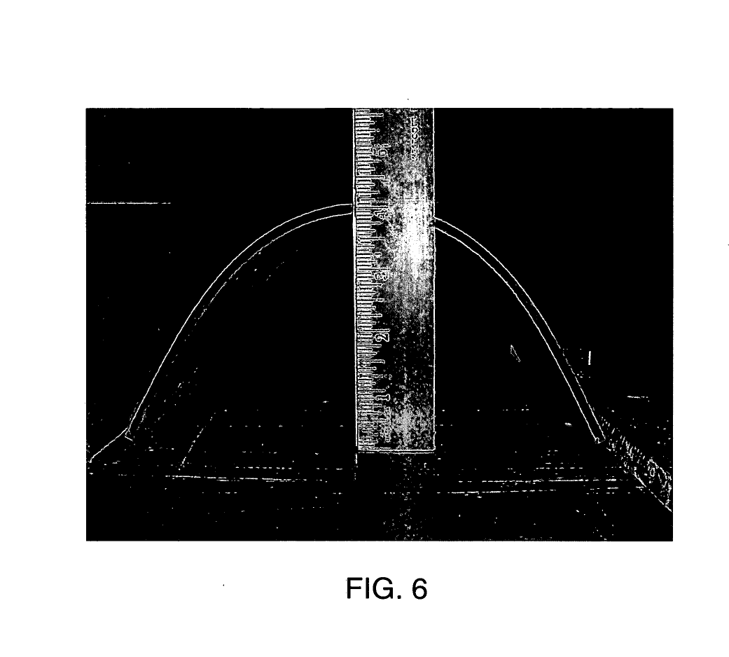

FIG. 6 is the membrane panel of the composition Mix 1 of Example 1;

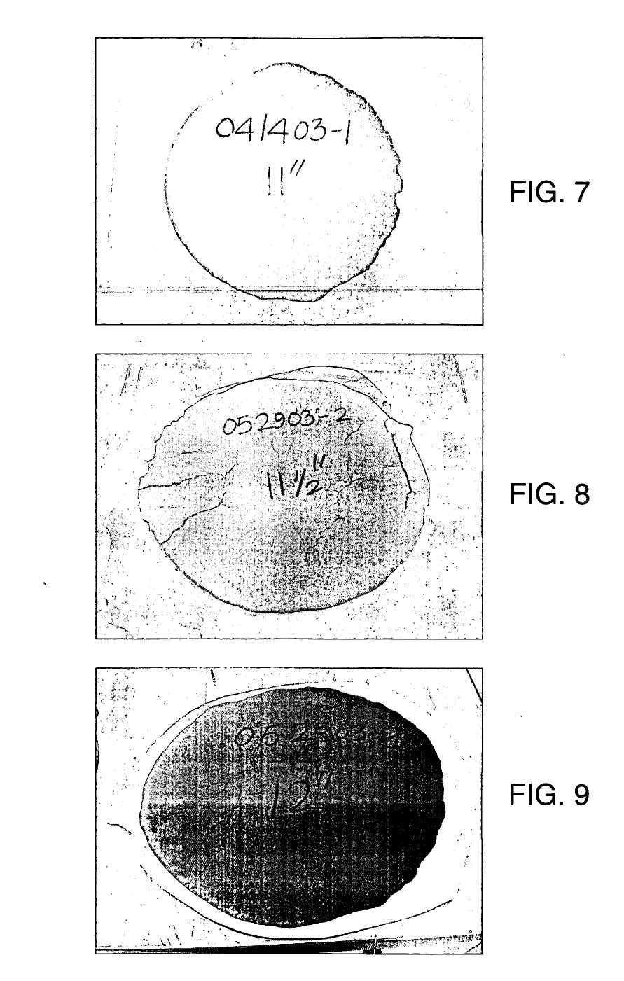

FIG. 7 shows a photograph of a patty test of Mix 1 of Example 1;

FIG. 8 shows a photograph of a patty test of Mix 2 of Example 2;

FIG. 9 shows a photograph of a patty test of Mix 3 of Example 2;

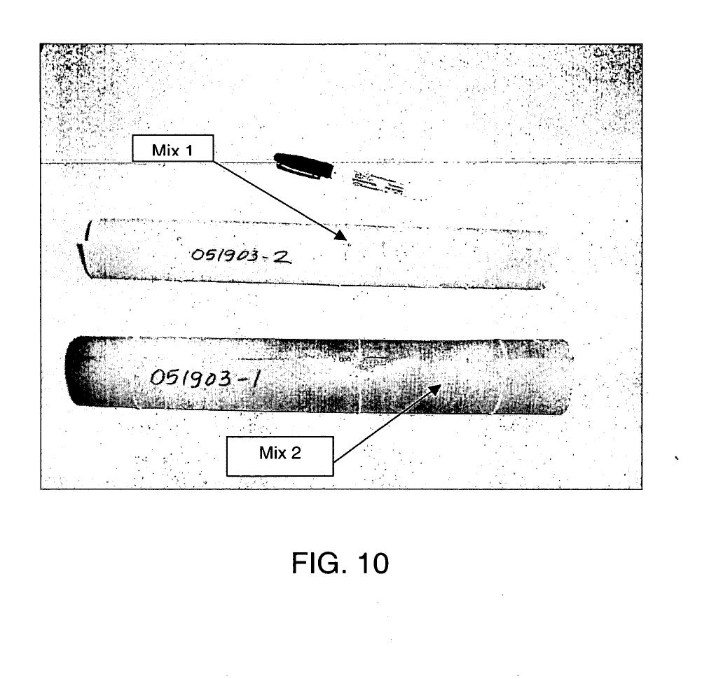

FIG. 10 demonstrates the roll into which the membrane of the present invention can be rolled;

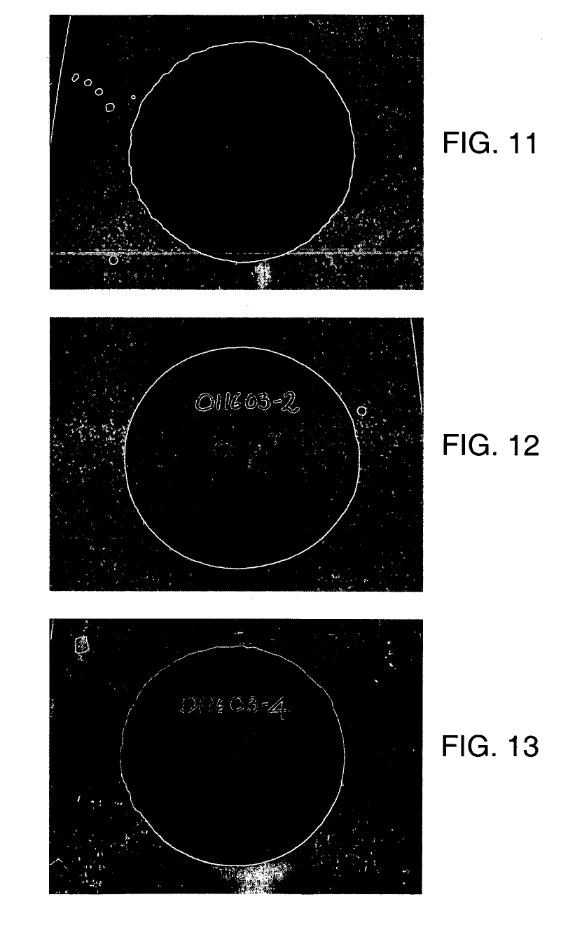

FIG. 11 shows a photograph of a patty test of Mix 5 of Example 7;

FIG. 12 shows a photograph of a patty test of Mix 6 of Example 7; and

FIG. 13 shows a photograph of a patty test of Mix 7 of Example 7.

### DETAILED DESCRIPTION OF THE INVENTION

Membranes made of flexible hydraulic materials are suitable for use, among other things, as underlayment for ceramic tiles. In a first embodiment, cementitious slurry is thinly applied to a mesh or scrim. Other embodiments do not require a support mesh when an optional water-soluble, film forming polymer is added to the cement slurry. Unless otherwise noted, amounts or concentrations reported herein describing the compositions are on a weight basis.

Any hydraulic materials are useful in the instant composition. Class C hydraulic fly ash, which is a high lime content fly ash obtained from the processing of certain coals, or its equivalent, is the most preferred hydraulic material. ASTM designation C-618 describes the characteristics of Class C fly ash (Bayou Ash Inc., Big Cajun, II, LA). When mixed with water, the fly ash sets similarly to a cement or gypsum. Use of other hydraulic materials in combination with fly ash are contemplated, including cements, including high alumina cements, calcium sulfates, including calcium sulfate anhydrite, calcium sulfate hemihydrate or calcium sulfate dihydrate, lime, other hydraulic materials and combinations thereof. Mixtures of fly ashes are also contemplated for use. Silica fume (SKW Silicium Becancour, St. Laurent, Quebec, Calif.) is another preferred material.

While not wishing to be bound by theory, it is believed that the shape of the fly ash particle contributes significantly to the characteristics of this composition. The spherical shape of fly ash creates a “ball bearing” effect in the mix, improving workability of the composition without increasing water requirements. In addition, some fly ashes have been shown to significantly decrease heat generation as the concrete hardens and strengthens. Fly ash, as do all pozzolanic materials, generally provides increased strength gain for much longer periods than mixes with Portland cement (St. Mary's Cement Inc., Detroit, Mich.) only.

Another reason fly ash is preferred in this composition is the increased life cycle expectancy and increase in durability associated with its use. During the hydration process, fly ash chemically reacts with the calcium hydroxide forming calcium silicate hydrate and calcium aluminate, which reduces the risk of leaching calcium hydroxide, making the composition less permeable. Fly ash also improves the permeability of hydraulic compositions by lowering the water-to-cement ratio, which reduces the volume of capillary pores remaining in the set composition. The spherical shape of fly ash improves the consolidation of the composition, which also reduces permeability. It is also theorized that tricalcium aluminate, which is frequently present in fly ash, acts as a set accelerator to speed up the setting reactions.

In some embodiments of the invention, the hydraulic component includes at least 50% hydraulic fly ash by weight. Preferably, the hydraulic component includes at least 55% hydraulic fly ash. More preferably, the hydraulic component includes at least 60% hydraulic fly ash. More preferably, the hydraulic component includes at least 65% hydraulic fly ash. More preferably, the hydraulic component includes at least 70% hydraulic fly ash. More preferably, the hydraulic component includes at least 75% hydraulic fly ash. More preferably, the hydraulic component includes at least 80% hydraulic fly ash. More preferably, the hydraulic component includes at least 85% hydraulic fly ash. More preferably, the hydraulic component includes at least 90% hydraulic fly ash. More preferably, the hydraulic component includes at least 95% hydraulic fly ash. More preferably, the hydraulic component includes at least 99% hydraulic fly ash. The remainder of the hydraulic component includes any hydraulic materials or mixtures thereof.

The total composition preferably includes from about 40% to about 92.5% by weight of the hydraulic component. More preferably, the hydraulic component makes up from about 45% to about 92.5% by weight of the composition. More preferably, the hydraulic component makes up from about 50% to about 92.5% by weight of the composition. More preferably, the hydraulic component makes up from about 55% to about 92.5% by weight of the composition. More preferably, the hydraulic component makes up from about 60% to about 92.5% by weight of the composition. More preferably, the hydraulic component makes up from about 65% to about 92.5% by weight of the composition. More preferably, the hydraulic component makes up from about 45% to about 85% by weight of the composition. More preferably, the hydraulic component makes up from about 50% to about 85% by weight of the composition. More preferably, the hydraulic component makes up from about 55% to about 85% by weight of the composition. More preferably, the hydraulic component makes up from about 60% to about 85% by weight of the composition. More preferably, the hydraulic component makes up from about 65% to about 85% by weight of the composition. More preferably, the hydraulic component makes up from about 40% to about 80% by weight of the composition. More preferably, the hydraulic component makes up from about 45% to about 80% by weight of the composition. More preferably, the hydraulic component makes up from about 50% to about 80% by weight of the composition. More preferably, the hydraulic component makes up from about 55% to about 80% by weight of the composition. More preferably, the hydraulic component makes up from about 60% to about 80% by weight of the composition. More preferably, the hydraulic component makes up from about 65% to about 80% by weight of the composition. More preferably, the hydraulic component makes up from about 40% to about 75% by weight of the composition. More preferably, the hydraulic component makes up from about 45% to about 75% by weight of the composition. More preferably, the hydraulic component makes up from about 50% to about 75% by weight of the composition. More preferably, the hydraulic component makes up from about 55% to about 75% by weight of the composition. More preferably, the hydraulic component makes up from about 60% to about 75% by weight of the composition. More preferably, the hydraulic component makes up from about 65% to about 75% by weight of the composition.

The optional polymer is a water-soluble, film-forming polymer, preferably a latex polymer. The polymer can be used in either liquid form or as a redispersible powder. A particularly preferred latex polymer is a methyl methacrylate copolymer of acrylic acid and butyl acetate (Forton VF 774 Polymer, EPS Inc. Marengo, Ill.).

Although the polymer is added in any useful amount, it is preferably added in amounts of from about 5% to 35% on a dry solids basis. More preferably, the composition includes from about 10% to about 35% polymer. More preferably, the composition includes from about 15% to about 35% polymer. More preferably, the composition includes from about 20% to about 35% polymer. More preferably, the composition includes from about 5% to about 30% polymer. More preferably, the composition includes from about 10% to about 30% polymer. More preferably, the composition includes from about 15% to about 30% polymer. More preferably, the composition includes from about 20% to about 30% polymer. More preferably, the composition includes from about 5% to about 25% polymer. More preferably, the composition includes from about 10% to about 25% polymer. More preferably, the composition includes from about 10% to about 20% polymer. More preferably, the composition includes from about 15% to about 20% polymer. More preferably, the composition includes from about 5% to about 15% polymer. More preferably, the composition includes from about 10% to about 15% polymer.

In order to form two interlocking matrix structures, water must be present in this composition. The total water in the composition should be considered when adding water to the system. If the latex polymer is supplied in liquid form, water used to disperse the polymer should be included in the composition water. Any amount of water can be used that produces a flowable mixture. Preferably, about 5 to about 35% water by weight is used in the composition. More preferably, the amount of water ranges from about 10% to about 35% by weight. More preferably, the amount of water ranges from about 15% to about 35% by weight. More preferably, the amount of water ranges from about 20% to about 35% by weight. More preferably, the amount of water ranges from about 25% to about 35% by weight. More preferably, the amount of water ranges from about 30% to about 35% by weight. More preferably, the amount of water ranges from about 15% to about 30% by weight. More preferably, the amount of water ranges from about 10% to about 30% by weight. More preferably, the amount of water ranges from about 20% to about 30% by weight. More preferably, the amount of water ranges from about 25% to about 30% by weight. More preferably, the amount of water ranges from about 15% to about 25% by weight. More preferably, the amount of water ranges from about 10% to about 25% by weight. More preferably, the amount of water ranges from about 20% to about 25% by weight. More preferably, the amount of water ranges from about 15% to about 20% by weight. More preferably, the amount of water ranges from about 10% to about 20% by weight of water per 100 parts of dry hydraulic component.

The addition of water to the hydraulic material initiates hydration reactions. Water of hydration is absorbed from the slurry to form the crystalline matrix of the cementitious material. As the free water decreases, the polymer begins forming a film and hardens. Since both of these processes occur virtually simultaneously, the crystalline matrix of the cementitious material and the polymer film become intimately intertwined in each other, forming strong links between these two substances.

In another embodiment, a thin layer of polymer-free cementitious material is applied to a scrim or base mat that is useful as an inexpensive and lightweight underlayment for ceramic tiles. Portland cement is a preferred hydraulic material, although the use of fly ash, other cements, including high alumina cements, calcium sulfates, including calcium sulfate anhydrite, calcium sulfate hemihydrate or calcium sulfate dihydrate, lime, other hydraulic materials and combinations thereof are contemplated for use in this embodiment. When used in combination with Portland cement, fly ash is preferably used in amounts of up to 60% of the total weight of hydraulic component. More preferably, fly ash is at least 10% of the total weight of the hydraulic component. More preferably, fly ash is at least 20% of the total weight of the hydraulic component. More preferably, fly ash is at least 30% of the total weight of the hydraulic component. More preferably, fly ash is at least 40% of the total weight of the hydraulic component. More preferably, the hydraulic materials include from about 40% fly ash to about 60% fly ash. Class C fly ash is the preferred fly ash.

The membrane of this embodiment is preferably less than ⅛″ (3 mm) in thickness. Although the polymeric compositions described above are applicable to a wide variety of uses, cementitious compositions without polymer are obtainable having sufficient flexibility for use as a membrane. A thin layer of a hydraulic material is applied to a base mat. The amount of water added is sufficient to form a flowable mixture. When a homogeneous mixture is obtained, the slurry is applied as a thin coating to the base mat. Preferably the coating is thin enough that no appreciable thickness is added to the base mat, but only the holes are filled in.

Any well-known additives for cements or polymer cements can be useful in any of the embodiments of the instant composition to modify it for a specific purpose of application. Fillers are added for a variety of reasons. The composition or finished product can be made even more lightweight if lightweight fillers, such as expanded perlite, other expanded materials or either glass, ceramic or plastic microspheres, are added. Microspheres reduce the weight of the overall product by encapsulating gaseous materials into tiny bubbles that are incorporated into the composition thereby reducing its density. Foaming agents used in conventional amounts are also useful for reducing the product density.

Conventional inorganic fillers and aggregates are also useful to reduce cost and decrease shrinkage cracking. Typical fillers include sand, talc, mica, calcium carbonate, calcined clays, pumice, crushed or expanded perlite, volcanic ash, rice husk ash, diatomaceous earth, slag, metakaolin, and other pozzolanic materials. Amounts of these materials should not exceed the point where properties such as strength are adversely affected. When very thin membranes or underlayments are being prepared, the use of very small fillers, such as sand or microspheres are preferred.

Colorants are optionally added to change the color of the composition or finished articles. Fly ash is typically gray in color, with the Class C fly ash usually lighter than Class F fly ash. Any dyes or pigments that are comparable with the composition may be used. Titanium dioxide is optionally used as a whitener. A preferred colorant is Ajack Black from Solution Dispersions, Cynthiana, Ky.

Set control additives that either accelerate or retard the setting time of the hydraulic component are contemplates for use in these compositions. The exact additives will depend on the hydraulic materials being used and the degree to which the set time is being modified.

Reinforcing materials can be used to add strength to the composition. The additional of fibers or meshes optionally help hold the composition together. Steel fibers, plastic fibers, such as polypropylene and polyvinyl alcohols, and fiberglass are recommended, but the scope of reinforcing materials is not limited hereby.

Superplasticizer additives are known to improve the fluidity of a hydraulic slurry. They disperse the molecules in solution so that they move more easily relative to each other, thereby improving the flowability of the entire slurry. Polycarboxylates, sulfonated melamines and sulfonated naphthalenes are known as superplasticizers. Preferred superplasticizers include ADVA Cast by Grace Construction Products, Cambridge, Mass. and Dilflo GW Superplasticizer of Geo Specialty Chemicals, Cedartown, Ga.

Shrinkage reducing agents help decrease plastic shrinkage cracking as the product dries. These generally function to modify the surface tension so that the slurry flows together as it dries. Glycols are preferred shrinkage reducing agents.

The hydraulic material, polymer, water and any optional components are combined in a mixer and mixed until a homogeneous blend is obtained. Preferably, the mixer is a high shear mixer providing a short residence time. For small batches of product, a typical laboratory blender is a suitable mixing device. For larger commercial operations, the use of commercially available continuous mixers manufactured by the PFT GMBH and Co. KG, based in Iphofen, Germany, are suitable. The preferred mixers have the capability of mixing as well as pumping the slurry in a continuous manner to the point of application. These mixers have a mixing chamber where all solid dry materials are blended together with the liquid additives including water using a cage agitator rotating at a high speed. In the normal mode of operation, the blended cementitious slurry continuously exits the mixing chamber and is pumped forward by a progressive cavity pump (rotor-stator type pump) to the point of application. The preferred PFT mixer models for this invention include PFT Mixing Pump G4, PFT Mixing Pump G5, PFT Monojet 2.13, PFT Mixing Pump T2E, PFT Mixing Pump MS1 and MS2.

After mixing, a flowable liquid exits from the mixer and can be poured into a mold or extruder, onto release paper or onto a base mat for shaping into an appropriate shape. Any method may be used to shape the composition, including molding, extruding, calendaring, rolling, screeding, or any shaping method suitable for the article being produced. If a membrane for use as an underlayment for ceramic tile is being prepared, the composition is preferably rolled or screeded onto the base mat to form the membrane.

The composition is optionally formed on a base mat for strength and for ease in handling the finished sheets. Any suitable base mat material may be suitable for this application. Scrim, cloth, either woven or non-woven, fiber mesh, spunbond materials, and meltblown compositions are examples of workable base mats. Non-woven fibrous mats are made of polymeric materials, such as polypropylene, polyethylene, polyester or polyvinyl alcohol, or non-polymeric materials such as fiberglass.

Compared to non-woven materials, meshes and scrims are relatively larger strands or yarns that are oriented linearly. The yarns running in different directions may be spaced such that there are openings between the yarns, but use of mesh with no openings is also contemplated. The yarns may run in two or more directions and are suitably made of polymeric materials, including Kevlar, polypropylene, polyethylene, polyvinyl alcohol and polyesters inorganic materials, such as carbon and steel, natural fibers or a combination thereof. A preferred mesh material is a single layer of a polymer coated, glass, open weave mesh commonly known as fly screen mesh.

Referring now to FIGS. 1 and 2, the membrane, generally 10, comprises the hydraulic material 12 and the base mat, generally 14. Although a single ply base mat 14 is suitable, a multiple ply mat is often preferred. It is advantageous to combine different types of base mat 14 materials to create a base mat that is optimized for particular uses. When used as a membrane for ceramic tile, a three-ply composite base mat 14 is particularly advantageous. The use of fibrous materials is preferred to control structure and porosity. At least three individual plies or laminas possess different structure and porosity and serve different functions in the finished product. The preferred base mat is composed of at least two different types of laminas. The first lamina 20 type is highly porous, facilitating good slurry absorption. Non-woven fabrics from a spunbond process are preferred for the first lamina 20. The spunbond process is well known to artisans of fabric-making, and produces a high porosity lamina of long, continuous fibers that are virtually unending. The second lamina 22 type is preferably highly impervious to water, resisting migration of liquids across it. This layer is preferably made using a meltblown manufacturing process, which is also well-known in the art. A meltblown lamina 22 is composed of fibers that are short and fine, forming a network of fibers that is very dense and complex, making it difficult for liquids to pass through it.

A preferred base mat 14 for this invention includes one meltblown lamina 22 sandwiched between two spunbond laminas 20. The center meltblown lamina 22 resists migration of liquids across the base mat, adding to the resistance to the flow of water or other liquids across the membrane 10. The spunbond lamina 20 are placed on either side of the meltblown lamina 22 to provide high porosity. Porosity of the spunbond lamina 20 allows for good infiltration and absorption of the cementitious slurry. The large fibers become incorporated into the crystal matrix of the hydraulic material 12, forming a strong bond.

The lamina 20, 22 are bonded to each other my any suitable means. Three-ply composites are commercially available as an s-m-s laminate by Kimberly-Clark of Appleton, Wis. This product is made of polypropylene fibers. While providing a barrier to liquids, the material is still breathable, allowing water vapor to pass through it. Depending upon the end application and the performance requirements, other lamina may be more suitable for a particular application. U.S. Pat. No. 4,041,203, herein incorporated by reference, fully describes an s-m-s laminate and a method for making it.

In a commercial scale production line, the base mat 14 is unwound from a spool and run toward the mixing area. If the base mat 14 is permeable by the slurry of hydraulic material 12, an optional release paper is useful underneath the base mat to contain overspill of the slurry. With an impermeable base mat and proper design of the coating station, the need for the release paper can be eliminated. The base mat is aligned with and placed on a surface to be fed to coating equipment for application of the slurry.

Following preparation of the base mat 14, the cementitious slurry 12 is preferably applied to the base mat. Any coating apparatus is adaptable for use with the slurry 12, including rod coaters, curtain coaters, sprayers, extrusion, pultrusion, roller coaters, knife coaters, bar coaters and the like to coat the base mat and form a sheet. One preferred method of spreading the slurry is by utilizing a screed bar. A thin cementitious coating is obtained by keeping the screed bar in contact with the base mat. As a head of slurry builds up in front of the screed bar, the slurry spreads and uniformly covers the mat.

When spreading the slurry, it can be advantageous to position the screed bar over a flexible surface. Pressure is applied to the screed bar to build up a head and to obtain a thin coating of slurry. In testing, when pressure was applied with the base mat positioned over a firm surface, the base mat stopped moving to started to tear. Moving the coating operation to a portion of the line where the base mat was supported by a flexible belt allowed sufficient pressure to be applied to the mat to obtain a thin coating without bunching or tearing of the base mat.

Thicker coatings of slurry are obtainable by repeating the coating process multiple times. If it is desirable to have a non-directional sheet, the cementitious slurry 12 is applicable to both sides of the base mat. When no base mat 14 is used, the slurry can be coated onto release paper and the paper removed when the product is set and dry.

After the slurry 12 has been applied to the base mat 14, it is allowed to dry, set and harden. Any method of drying the slurry is useful, including, air drying at room temperature, oven or kiln drying or drying in a microwave oven. When allowed to dry at room temperature, the membrane is ready to use or to store in a few hours. More preferably, the coated mat or coated paper is sent to an oven where it dries and sets rapidly. A slurry thinly applied to a base mat dries in less than 10 minutes in a 175° F. (80° C.) oven. Exact drying times will depend on the exact composition chosen, the thickness of the slurry and the drying temperature. When the composition is set, the release paper, if present, is removed by conventional methods.

Referring now to FIGS. 3 and 4, when the membrane 10 is shipped or stored in the form of a roll, the preferred packaging is a cylindrical tube, generally 30. The tube 30 may be constructed of any material, however, to minimize the product cost, a fibre tube is the preferred package. Many types of plastic would also be suitable for manufacture of the tube, including polyethylene, polypropylene, polyester and polyvinyl chloride. Any other packaging materials, such as corrugate or metal foils, are also suitable for use in manufacturing the package. Reinforcing is optionally added where the tube 30 is large or the membrane 10 is heavy. Choice of the packaging material is at the discretion of the manufacturer and depends on the properties that the user wishes to impart to the package. Heavier packaging materials is optionally used where it is necessary to trade weight for a greater degree of protection.

The packaging tube 30 is most suitably sized to accommodate the membrane 10 when rolled up for placement inside the tube. It is most advantageous that the package 30 protects the rolled membrane from being flattened to an oval so that it does not roll when applied on the job. Like an architectural arch, force applied to one area of the tube is distributed around it due to the shape. Other aspects of the tube 30 should be designed to protect the membrane within it from being punctured, scratched, crushed or otherwise damaged during storage or shipping.

Preferably the tube 30 has an inner cylinder 32 and an outer cylinder 34 for strength to prevent the contents from being creased or crushed. The inner cylinder may be attached to the outer cylinder in any suitable fashion. Preferably, the inner cylinder is not attached, but is sized to remain in place by friction with the outer cylinder. When considering the interior length of the package, allowance should be made for the tolerances of the manufacturing process and allowance for head space in the tube so that the ends of the membrane are not damaged. The inner diameter of the inner cylinder 32 should be slightly greater than the outer diameter of the rolled membrane 10. Walls of the inner cylinder 32 and the outer cylinder 34 should have sufficient thickness to hold the weight of the membrane 10 and to protect it.

Preferably the tube 30 is a two-section, telescoping tube. This type of packaging tube opens by separating into two sections, a first section 36 and a section 38. Where both an inner cylinder 32 and an outer cylinder 34 are present, the inner cylinder 32 is designated 32a in the second section and 32b in the first section. Similarly, the outer cylinder 34 is designated 34b in the first section and 34a in the second section.

The first section 36 is differentiated from the second section 38 in that the inner cylinder 32b of the first section is longer than the outer cylinder 34b. However, the length of inner cylinder 32b is preferably shorter then the height of the rolled membrane 10. In this configuration, the rolled membrane 10 extends upward from the inside from the first section 36 of the tube 30. This produces an exposed portion of the membrane 10 to be grasped for easy removal of the membrane 10 from the tube 30. Use of the inner cylinder 32a is optional. If inner cylinder 32b is sufficiently long to provide protection for the rolled membrane 10, inner cylinder 32a is omitted.

The second section 38 of the package has the inner cylinder 32a that is shorter than the outer cylinder 34a, producing a recess on the inside of the second section 38 to accept the extended inner cylinder 32b of the first section 36. Thus, the first section 36 matingly engages with the second section 38 by interfitting of the portions of the inner cylinder 32a, 32b and outer cylinders 34a, 34b.

Each of the first section 36 and the second section 38 includes an end cap 40 that closes the end of the tube 30. Preferably, the end cap 40 is a portion of a plane that intersects the tube 30 at approximately a right angle. End caps 40 having other shapes are also useful, as will be known by an artisan. Any material that holds the product in place and that protects the product is useful for making the end caps 40. Cardboard, fiberboard and plastic are preferred for making the end caps. The end caps 40 need not be constructed of the same material as other parts of the tube 30. The distance between end caps 40 is sufficiently long to hold the rolled membrane 10 inside the tube 30 between them. A preferred method of attaching the end cap 40 to the tube 30 is by providing a flange (not shown) around the outer edge of the end cap and setting the end cap approximately ½ inch (1 cm) within the tube. The flange is then stapled to the tube to hold it in place.

When the first and second sections 36, 38 are together to close the tube 30, friction between the first and second sections 36, 38 is usually sufficient to hold the package closed. If desired, additional closures (not shown) may be added to hold the package securely, including Velcro® brand fasteners (3M Company, Minneapolis, Minn.) or other closing mechanisms as are known in the art. Preferably, a product label (not shown) is affixed at the joint between the first and second sections 36, 38 so that the label adheres to both sections, holding them together. Optionally, the label includes information as to the product name, the size of the product enclosed, recommended uses and the like.

Manufacture of packaging tubes is well known to one skilled in the art. Preferred tubes are known as “three-piece telescoping tubes with plastic plugs, stapled” and are available from Caraustar Industries' Saginaw Tube Plant of Saginaw, Mich.

In the examples that follow, all components are measured by weight unless otherwise stated. The latex polymer used here, Forton VF774, was in a liquid form and included 51% polymer solids and 49% water. In the examples that follow, “water” refers to added water and does not include that in the latex polymer. Of the amounts reported for the polymer, 51% of the amount is in the form of dry solids.

### EXAMPLE 1

A slurry was made from the components from Mix 1 of Table 1. No water in addition to that contained in the liquid polymer was added to form the slurry.

TABLE I
Components of Examples 1-4

| Component | Trade Name | Mix 1 | Mix 2 | Mix 3 |
|---|---|---|---|---|
| Class C Fly Ash | Bayou | 66.8% | 32.2% | 0 |
| Portland cement | | 0 | 32.2% | 62.4% |
| Water | | 0 | 3.53% | 6.54% |
| Acrylic Polymer | Forton VF774 | 32.8% | 31.58% | 30.60% |
| Latex | | | | |
| Polycarboxylate | Adva Cast | 0.3% | 0.3% | 0.3% |
| Superplasticizer | | | | |
| Colorant | Ajack Black 8044 | 0.13% | 0.13% | 0.13% |

All of the above components were placed in a high-shear blender and blended for 30 seconds to form a slurry. A panel ¼″ (0.6 mm) in thickness and measuring 6″×12″ (15 cm×30 cm) was also cast in the laboratory from the slurry. It was dried at room temperature for several hours. As the panel dried, there was no shrinkage cracking of the material. The nature of the composite was similar to that of rubber, only it was harder and more flexible.

The flexibility of the resulting panel is demonstrated in FIG. 5. The panel was flexed along its 12″ (30 cm) length until an arch approximately 4″ (10 cm) in height was formed. There was no visible cracking as a result of flexing the material. Even after such large deformations, the panel regained its original shape with no signs of damage.

Fatigue of the material was tested by repeated flexing of the cast flat panel into a 4″ (10 cm) arch as shown in FIG. 5. After 50 such flexings, there was no sign of cracking or damage. The material has an ultimate tensile strain capacity of >2% and a tensile toughness of 30 inch-pounds per square inch (435 N-m/m²).

The flow behavior of the slurry was characterized by filling a calibrated brass cylinder 4″ (10.2 cm) in height and 2″ (5.1 cm) in internal diameter with the slurry. The cylinder was lifted up, allowing the slurry to exit from the bottom of the cylinder and spread. An 11″ (28 cm), self-leveled patty formed from the slurry, as shown in FIG. 6.

### EXAMPLE 2

A slurry from each of Mix 2 and Mix 3 in Table 1 was prepared according to the method of Example 1. Circular patties were cast from each of the slurries as described in Example 1 and allowed to dry. The patty from Mix 2 is shown in FIG. 7, while FIG. 8 shows the patty of Mix 3. Mixes 2 and 3 developed significant shrinkage cracking as the patty dried, most of it within the first two hours after casting. The fly ash composition of Example 1 developed no cracking at all as shown in FIG. 6. This demonstrates the superior shrinkage cracking resistance and dimensional stability of compositions that include more than 50% fly ash.

### EXAMPLE 3

Tensile properties of a sample of Mix 1 were tested in a Model 810 close-loop, displacement-controlled testing machine by MTS Systems Corp. of Eden Prairie, MN. A rectangular specimen was prepared measuring 8″ in length, 2″ wide and ¼″ in thickness. Notches ½″ long were cut on both sides of the specimen at mid height. Testing was conducted when the specimen was 28 days of age. Results of the tests are shown in Table II below.

TABLE II
Physical Properties of Mix 1

| Property | Mix 1 | | Plain Concrete | |
|---|---|---|---|---|
| Ultimate Tensile Strain (%) | 2.00 | | 0.01 | |
| Tensile Toughness (lb-inch/inch²) | 32.0 | (5.72)^{a} | 0.12 | (.02)^{a} |
| Tensile Strength (psi) | 246 | (17.3)^{b} | 290 | (20.4)^{b} |
| Modulus of Elasticity (psi) | 279 | (19.7)^{b} | 20000 | (1409)^{b} |

^{a}Kg-cm/cm²
^{b}Kg/cm²

Results for concrete are those reported in the literature. “Plain concrete” is the set product of Portland cement, sand, aggregate and water. This test shows that the fly ash composition has exceptional ductility and toughness as indicated by the ultimate tensile strain and tensile toughness numbers. Tensile toughness represents energy required to fracture a specimen per unit cross-sectional area. In both of these tests, the fly ash composition of Mix 1 showed tensile strain and tensile toughness about 200 times greater than concrete. Increased elasticity, approaching that of rubber, is measured by the severe decrease in the modulus of elasticity over concrete.

### EXAMPLE 4

A cementitious membrane was prepared using the same composition of Example 1. The raw materials of Table I were added to a high-shear blender and blended for 30 seconds. The resulting cementitious slurry was applied by trowel as a coating on both sides of a piece of SMS Laminate base mat. The resulting product was allowed to dry for two hours and was subsequently put in the form of a roll of 1″ (2.5 cm) in diameter.

### EXAMPLE 5

Another cementitious membrane was made by again mixing the components of Table I and applying it to both sides of the SMS Laminate base mat. The resulting coated product was transferred to a 210° F. (99° C.) oven for three minutes. Subsequently, it was removed from the oven and rolled less than 4 minutes after the slurry was applied to the base mat.

### EXAMPLE 6

Two flexible membranes were manufactured using a bi-directional mesh base mat made of polyvinyl chloride coated fiberglass. The mesh had an open and porous structure with 9 fiberglass yarns per inch, running in both the warp and weft directions. The two hydraulic compositions of Table III were each applied to a piece of this base mat.

TABLE III
Components of Example 6

| | Mix 1 | Mix 4 |
|---|---|---|
| Ingredient | (wt %) | (wt %) |
| Class C Fly Ash (Bayou) | 66.79 | 62.42 |
| Water | 0.00 | 6.70 |
| Acrylic Polymer Latex^{a} (Forton VF774) | 32.74 | 30.59 |
| Polymer solids content - 51% and | | |
| Water content - 49% | | |
| Polycarboxylate superplasticizer (Adva | 0.34 | 0.16 |
| Cast) | | |
| Colorant (Ajack Black AJ 61) | 0.13 | 0.13 |

FIG. 9 shows a photograph of the two membranes using the fiberglass mesh base mat. As shown, the fiberglass mesh was completely coated and embedded with the fly ash composition of the invention. Flexibility and foldability of the finished product is shown by the tight rolls less than 1″ (2.54 cm) in diameter (compared to the pen, also shown) into which the membrane is rolled.

### EXAMPLE 7

The use of other pozzolanic materials was tested by replacing a portion of the fly ash with other pozzolans. Three compositions were made using silica fume, as shown in Table IV below.

TABLE IV
Components of Example 7

| Ingredient | Mix 5 | Mix 6 | Mix 7 |
|---|---|---|---|
| Class C Fly Ash (Bayshore, MI) | 58.06 | 59.37 | 62.91 |
| Silica Fume | 6.45 | 3.13 | 3.31 |
| Water | 3.21 | 6.86 | 0.65 |
| Acrylic Polymer Latex (Forton VF77) | 31.63 | 30.64 | 32.47 |
| Polymer solids content - 51% and | | | |
| Water content - 49% | | | |
| Polycarboxylate superplasticizer | 0.65 | 0.00 | 0.66 |
| (Adva Cast) | | | |
| Colorant (Ajack Black AJ 61) | 0.00 | 0.00 | 0.00 |

The mixes in Table IV above were mixed and subjected to the patty test described in Example 1. In Mix 5, 10% of the fly ash was replaced with silica fume. Mixes 6 and 7 replaced only 5% of the fly ash with silica fume. A superplasticizer was added to Mixes 5 and 7, but not to Mix 6.

Patties cast using Mix 5, Mix 6 and Mix 7 are shown in FIGS. 10, 11 and 12, respectively. All patties were self-leveling and produced no stress cracks.

### EXAMPLE 8

A membrane was prepared by using the components listed in Table V.

TABLE V
Components of Example 8

| | | %, by weight |
|---|---|---|
| Component | Amount | hydraulic component |
| Portland Cement, | 100 parts | 46.5% |
| Type III | | |
| Class C fly ash | 95 parts | 44.2% |
| High Alumina Cement | 15 parts | 7.0% |
| Landplaster | 5 parts | 2.3% |
| Silica Sand | 408 parts by weight | 190% |
| Water | q.s. to make 8″ patty | |

The above hydraulic mixture was prepared and applied by squeegee to a single layer of a polymer coated, glass, open weave mesh commonly known as fly screen mesh, and allowed to dry. The membrane was able to be rolled in a manner similar to vinyl flooring.

Two samples of the underlayment were tested using the ASTM C627 Robinson Floor Test, herein incorporated by reference. Sample floors for the test were prepared on a ¾″ (19 mm) oriented strand board (OSB) of wood. The underlayment was attached to the OSB using mastic. No mechanical fasteners were used. Two-inch (5 cm) ceramic tiles were then laid on the underlayment using a thin-set adhesive, then the tiles were grouted. The samples were allowed to cure at least 28 days from the date of manufacture before the test was performed.

During the Robinson Floor Test, wheels of varying hardness and carrying varying loads are sequentially moved over the tile surface for 900 revolutions each. After each cycle, the tiles are studied to determine if any of them are loose, broken or chipped. The grout is examined to establish if it has popped, cracked or powdered.

Neither of the two samples showed any defects in the tile or grout through the 6^{th} cycle of the test. One of the samples failed on the 7^{th} cycle, while the second sample passed the 8^{th} cycle of the test.

### EXAMPLE 9

A cylindrical package was made for a three-foot (2.76 m) by 100-foot (92.3 m) sheet of membrane. The membrane was rolled easily without the need for a central tube to support the membrane. After rolling, the membrane was inserted into the first section of the package. Both the first section and the second section had both an inner cylinder and an outer cylinder. The diameter of the inside cylinder was 5.75 inches (14.6 cm). The interior length of the outer cylinder was 36.5 inches (92.7 cm), while the inner cylinder was 30 inches (76.2 cm) long. The length of the outer cylinder of the first section was 24.75 inches (62.9 cm), and the length of the outer cylinder of the second section was 12.625 inches (32.1 cm). Five and three-eights inches (13.6 cm) of the inner cylinder extended beyond the outer cylinder of the first section. Correspondingly, the inner cylinder was 5.375 inches (13.6 cm) shorter than the outer cylinder on the second section.

To close the package, the extending portion of the inner cylinder of the first portion is aligned with the recess in the inner cylinder of the second portion. The portions are then slid together to close the package. No additional closure was used. When closed, the extension of the inner cylinder of the first portion fits into the space left by the recess in the inner cylinder of the second portion, matingly engaging the two portions.

To remove the membrane from the cardboard package, it is opened by overcoming the friction and separating the first portion from the second portion. The membrane is grasped by the portion of the membrane that protrudes from the first portion of the package, and gently pulled from the tube.

While particular embodiments of the present fly ash composition and method for making it has been shown and described, it will be appreciated by those skilled in the art that any embodiment of the membrane may be used with any embodiment of the package, and that other changes and modifications may be made thereto without departing from the invention in its broader aspects and as set forth in the following claims.

What is claimed is:

1. A packaged membrane adapted to be sold, stored and transported to the site of use comprising:
a tubular package; and
a membrane, said membrane comprising a base mat and a flexible coating applied to said base mat, said coating comprising a hydrated hydraulic component, said membrane being rolled and packaged in said tubular package.

2. The packaged membrane of claim 1 wherein said coating further comprises a water-soluble, film-forming polymer.

3. The packaged membrane of claim 1 wherein said hydraulic component further comprises at least 50% fly ash by weight.

4. The packaged membrane of claim 1 wherein said tubular package comprises at least a first portion and a second portion that matingly engage to form said package.

5. The packaged membrane of claim 1 wherein said membrane is rolled without a central tube inside the membrane roll.

6. The packaged membrane of claim 1 wherein said package comprises at least an inner cylinder and an outer cylinder.

7. The packaged membrane of claim 1 wherein said package comprises plastic or cardboard.

8. The packaged membrane of claim 1 wherein said membrane protrudes from said package when said package is opened.

9. The packaged membrane of claim 1 wherein said package is configured to protect said rolled membrane from being flattened or crushed during at least one of storage or shipping.

10. A packaged membrane comprising:
a tubular package; and
a coated membrane, said coated membrane comprising a base mat including at least three plies, a center ply of a meltblown polymer sandwiched between two plies of spunbond polymer, and a flexible coating applied to said base mat, said coating comprising a hydrated mixture of a hydraulic component and a water-soluble, film-forming polymer, and wherein said membrane is rolled and packaged in said tubular package.

11. The packaged membrane of claim 10 wherein said tubular package comprises at least a first portion and a second portion that matingly engage to form said package.

12. The packaged membrane of claim 10 wherein said package comprises at least one of cardboard and plastic.

13. The packaged membrane of claim 10 wherein said package comprises an inner cylinder and an outer cylinder.

14. The packaged membrane of claim 10 wherein said membrane is rolled without a central supporting tube.

15. The packaged membrane of claim 10 wherein said hydraulic component further comprises fly ash.

16. The packaged membrane of claim 10 wherein said polymer comprises a latex polymer.

17. The packaged membrane of claim 10 wherein said membrane is coated on both sides.
